(19) United States
(12) Patent Application Publication
(10) Pub. No.: US 2023/0196795 A1
(43) Pub. Date: Jun. 22, 2023

(54) PATTERN DETECTION WITH SHADOW BOUNDARY USING SLOPE OF BRIGHTNESS

(71) Applicant: VEONEER US, INC., SOUTHFIELD, MI (US)

(72) Inventors: Afrah Naik, Southfield, MI (US); Caroline Chung, Southfield, MI (US); Mitchell Pleune, Southfield, MI (US)

(73) Assignee: VEONEER US, INC., SOUTHFIELD, MI (US)

(21) Appl. No.: 17/556,296

(22) Filed: Dec. 20, 2021

(51) Int. Cl. G06V 20/59; G06T 7/70; G06V 10/75

(52) U.S. Cl. CPC G06V 20/59; G06T 7/70; G06V 10/751; G06T 2207/10048; G06T 2207/30268

(57) ABSTRACT

A method for detecting an object having a known pattern with a boundary of a shadow overlying the known pattern includes: capturing, by a camera, a source image of the object; detecting a plurality of transitions between dark and bright regions of the source image and corresponding to the known pattern; determining an expected transition within the source image based on the known pattern and the detected transitions; determining an absence of the expected transition due to the boundary of the shadow overlying the known pattern; and determining a location in the source image corresponding to the expected transition based on a rate of change of brightness in the source image. A system including a camera and a controller configured to detect an object having a known pattern with a boundary of a shadow overlying the known pattern is also provided.

### BACKGROUND

### 1. Field of the Invention

The present invention generally relates systems and methods for a vision-based system to detect an object, such as a seatbelt, having a known pattern with a boundary of a shadow overlying the known pattern.

### 2. Description of Related Art

Cameras and other image detection devices have been utilized to detect one or more objects. Control systems that are in communication with these cameras can receive images captured by the cameras and process these images. The processing of these images can include detecting one or more objects found in the captured images. Based on these detected objects, the control system may perform some type of action in response to these detected variables.

Conventional systems for detecting seatbelt usage typically rely upon a seat belt buckle switch. However, those conventional systems are unable to detect if the seatbelt is properly positioned or if the seat belt buckle is being spoofed. Seat track sensors are typically used to determine distance to an occupant of a motor vehicle. However, such use of seat track sensors do not account for body position of the occupant relative to the seat.

Conventional vision-based systems and methods have difficulty detecting patterns of objects where a boundary of a shadow overlies the pattern.

### SUMMARY

A method for detecting an object having a known pattern with a boundary of a shadow overlying the known pattern is provided. The method comprises: capturing, by a camera, a source image of the object; detecting a plurality of transitions between dark and bright regions of the source image and corresponding to the known pattern; determining an expected transition within the source image based on the known pattern and the detected transitions; determining an absence of the expected transition due to the boundary of the shadow overlying the known pattern; and determining a location in the source image corresponding to the expected transition based on a rate of change of brightness in the source image.

A system for detecting a position of an object having a known pattern with a boundary of a shadow overlying the known pattern is provided. The system comprises: a camera configured to capture a source image of the object; and a controller in communication with the camera. The controller is configured to: detect a plurality of transitions between dark and bright regions of the source image and corresponding to the known pattern; determine an expected transition within the source image based on the known pattern and the detected transitions; determine an absence of the expected transition due to the boundary of the shadow overlying the known pattern; and determine a location in the source image corresponding to the expected transition based on a rate of change of brightness in the source image.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a vehicle having a system for detecting proper seatbelt usage and for detecting distance to the seatbelt;

FIG. 2 illustrates a forward looking view of a cabin of the vehicle having a system for detecting proper seatbelt usage and for detecting distance to the seatbelt;

FIG. 3 illustrates a block diagram of the system for detecting proper seatbelt usage and for detecting distance to the seatbelt;

FIG. 4 illustrates a first example of improper seatbelt positioning;

FIG. 5 illustrates a second example of improper seatbelt positioning;

FIG. 6 illustrates a third example of improper seatbelt positioning;

FIG. 7 shows a flow chart of a method for detecting an object, in accordance with an aspect of the present disclosure;

FIG. 8A shows an image of an object with a known pattern and with a boundary of a shadow overlying the known pattern;

FIG. 8B shows a graph of brightness of pixels along a row of the image of FIG. 8A;

FIG. 8C shows a graph indicating a slope of brightness values of pixels along the row of the image of FIG. 8A; and

FIG. 9 shows a flowchart listing steps in a method for detecting an object having a known pattern with a boundary of a shadow overlying the known pattern.

### DETAILED DESCRIPTION

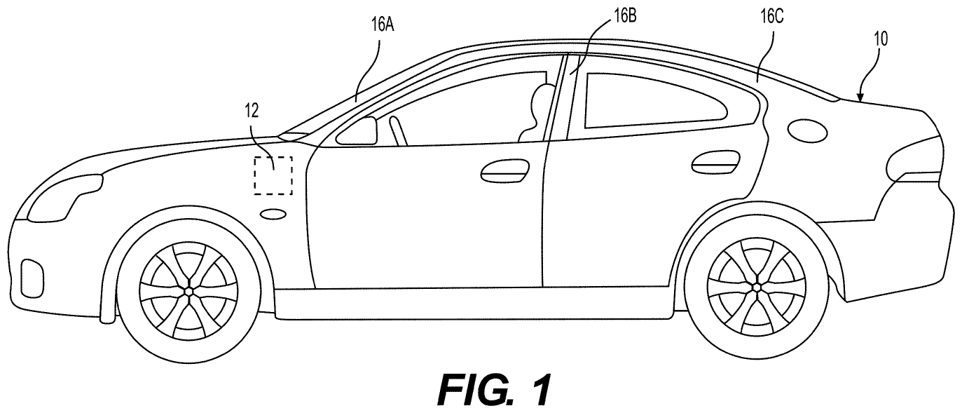

Referring to FIG. 1, illustrated is a vehicle 10 having a seatbelt detection system 12 for detecting proper seatbelt usage and/or for detecting distance to the seatbelt. In this example, the seatbelt detection system 12 has been incorporated within the vehicle 10. However, it should be understood that the seatbelt detection system 12 could be a standalone system separate from the vehicle 10. In some embodiments, the seatbelt detection system 12 may employ some or all components existing in the vehicle 10 for other systems and/or for other purposes, such as for driver monitoring in an advanced driver assistance system (ADAS). Thus, the seatbelt detection system 12 of the present disclosure may be implemented with very low additional costs.

As to the vehicle 10, the vehicle 10 is shown in FIG. 1 as a sedan type automobile. However, it should be understood that the vehicle 10 may be any type of vehicle capable of transporting persons or goods from one location to another. As such, the vehicle 10 could, in addition to being a sedan type automobile, could be a light truck, heavy-duty truck, tractor-trailer, tractor, mining vehicle, and the like. Also, it should be understood that the vehicle 10 is not limited to wheeled vehicles but could also include non-wheeled vehicles, such as aircraft and watercraft. Again, the term vehicle should be broadly understood to include any type of vehicle capable of transporting persons or goods from one location to another and it should not be limited to the specifically enumerated examples above.

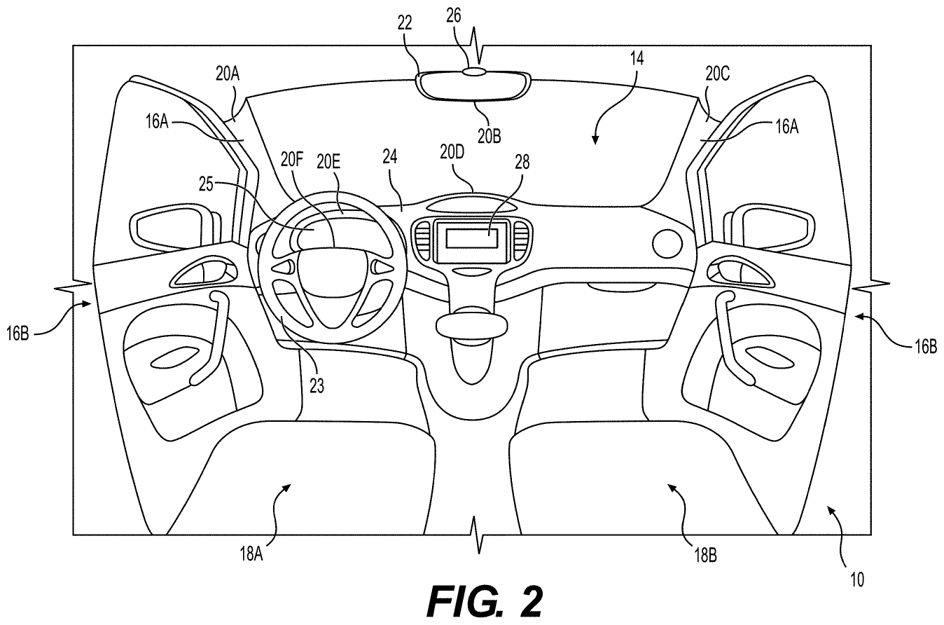

Referring to FIG. 2, a cabin 14 of the vehicle 10 is shown. As it is well understood in the art, the cabin 14 is essentially the interior of the vehicle 10 wherein occupants and/or goods are located when the vehicle is in motion. The cabin 14 of the vehicle may be defined by one or more pillars that structurally define the cabin 14. For example, in FIG. 2, A-pillars 16A and B-pillars 16B are shown. FIG. 1 further illustrates that there may be a third pillar or a C-pillar 16C. Of course, it should be understood that the vehicle 10 may contain any one of a number of pillars so as to define the cabin 14. Additionally, it should be understood that the vehicle 10 may be engineered so as to remove these pillars, essentially creating an open-air cabin 14 such as commonly found in automobiles with convertible tops.

Located within the cabin 14 are seats 18A and 18B. The seats 18A and 18B are such that they are configured so as to support an occupant of the vehicle 10. The vehicle 10 may have any number of seats. Furthermore, it should be understood that the vehicle 10 may not have any seats at all.

The vehicle 10 may have one or more cameras 20A-20F located and mounted to the vehicle 10 so as to be able to have a field a view of at least a portion of the cabin 14 that function as part of a vision system. As such, the cameras 20A-20F may have a field of view of the occupants seated in the seats 18A and/or 18B. Here, cameras 20A and 20C are located on the A-pillars 16A. Camera 20B is located on a rearview mirror 22. Camera 20D may be located on a dashboard 24 of the vehicle 10. Camera 20E and 20F may focus on the driver and/or occupant and may be located adjacent to the vehicle cluster 25 or a steering wheel 23, respectively. Of course, it should be understood that any one of a number of different cameras may be utilized. As such, it should be understood that only one camera may be utilized or numerous cameras may be utilized. Furthermore, the cameras 20A-20F may be located and mounted to the vehicle 10 anywhere so long as to have a view of at least a portion of the cabin 14.

The cameras 20A-20F may be any type of camera capable of capturing visual information. This visual information may be information within the visible spectrum, but could also be information outside of the visible spectrum, such as infrared or ultraviolet light. Here, the cameras 20A-20F are near infrared (NIR) cameras capable of capturing images generated by the reflection of near infrared light. Near infrared light may include any light in the near-infrared region of the electromagnetic spectrum (from 780 nm to 2500 nm). However, the seatbelt detection system 12 of the present disclosure may be configured to use a specific wavelength or range of wavelengths within the near-infrared region.

The source of this near-infrared light could be a natural source, such as the sun, but could also be an artificial source such as a near-infrared light source 26. The near-infrared light source 26 may be mounted anywhere within the cabin 14 of the vehicle 10 so as long as to be able to project near-infrared light into at least a portion of the cabin 14. Here, the near-infrared light source 26 is mounted to the rearview mirror 22 but should be understood that the near-infrared light source 26 may be mounted anywhere within the cabin 14. Additionally, it should be understood that while only one near-infrared light source 26 is shown, there may be more than one near-infrared light source 26 located within the cabin 14 of the vehicle 10.

Also located within the cabin 14 may be an output device 28 for relaying information to one or more occupants located within the cabin 14. Here, the output device 28 is shown in a display device so as to convey visual information to one or more occupants located within the cabin 14. However, it should be understood that the output device 28 could be any output device capable of providing information to one or more occupants located within the cabin 14. As such, for example, the output device may be an audio output device that provides audio information to one or more occupants located within the cabin 14 of a vehicle 10. Additionally, should be understood that the output device 28 could be a vehicle subsystem that controls the functionality of the vehicle.

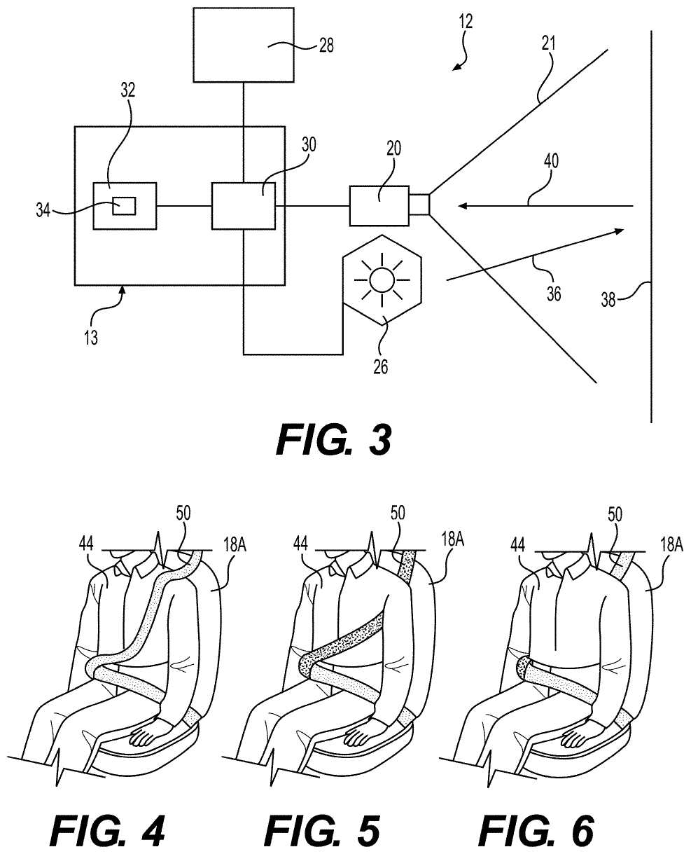

Referring to FIG. 3, a more detailed illustration of the seatbelt detection system 12 is shown. Here, the system 12 includes a control system 13 having a processor 30 in communication with a memory 32 that contains instructions 34 for executing any one of a number of different methods disclosed in this specification. The processor 30 may include a single stand-alone processor or it may include two or more processors, which may be distributed across multiple systems working together. The memory 32 may be any type of memory capable of storing digital information. For example, the memory may be solid-state memory, magnetic memory, optical memory, and the like. Additionally, it should be understood that the memory 32 may be incorporated within the processor 30 or may be separate from the processor 30 as shown.

The processor 30 may also be in communication with a camera 20. The camera 20 may be the same as cameras 20A-20F shown and described in FIG. 2. The camera 20, like the cameras 20A-20F in FIG. 2, may be a near-infrared camera. The camera 20 may include multiple physical devices, such as cameras 20A-20F illustrated in FIG. 2. The camera 20 has a field of view 21.

The near-infrared light source 26 may also be in communication with the processor 30. When activated by the processor 30, the near-infrared light source 26 projects near-infrared light 36 to an object 38 which may either absorb or reflect near-infrared light 40 towards the camera 20 wherein the camera can capture images illustrating the absorbed or reflected near-infrared light 40. These images may then be provided to the processor 30.

The processor 30 may also be in communication with the output device 28. The output device 28 may include a visual and/or audible output device capable of providing information to one or more occupants located within the cabin 14 of FIG. 2. Additionally, it should be understood that the output device 28 could be a vehicle system, such as a safety system that may take certain actions based on input received from the processor 30. For example, the processor 30 may instruct the output device 28 to limit or minimize the functions of the vehicle 10 of FIG. 1. As will be explained later in this specification, one of the functions that the seatbelt detection system 12 may perform is detecting if an occupant is properly wearing a safety belt. If the safety belt is not properly worn, the processor 30 could instruct the output device 28 to limit the functionality of the vehicle 10, such that the vehicle 10 can only travel at a greatly reduced speed.

FIG. 4 illustrates a first example of improper seatbelt positioning, showing a seatbelt 50 that is ill-adjusted on an occupant 44 sitting on a seat 18A of the vehicle 10. The ill-adjusted seatbelt 50 in this example, drapes loosely over the shoulder of the occupant 44. FIG. 5 illustrates a second example of improper seatbelt positioning, showing the seatbelt 50 passing under the armpit of the occupant 44. FIG. 6 illustrates a third example of improper seatbelt positioning, showing the seatbelt 50 passing behind the back of the occupant 44. The seatbelt detection system may detect other examples of improper seatbelt positioning, such as a seatbelt that is missing or which is not worn by the occupant 44, even in cases where the buckle is spoofed (e.g. by plugging-in the buckle with the seatbelt behind the occupant 44 or by placing a foreign object into the buckle latch).

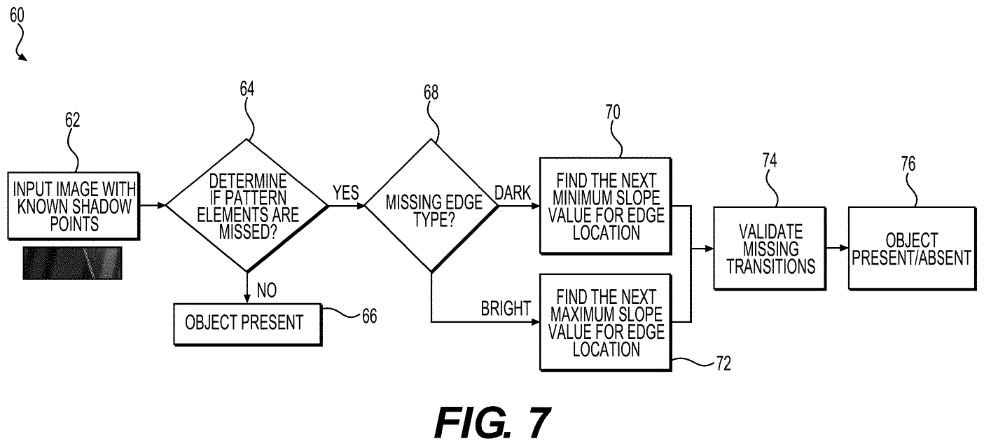

FIG. 7 shows a flow chart of a first method 60 for detecting an object. The object may be an object in a vehicle, such as a seatbelt 50. The first method 60 includes inputting an image with known shadow points at step 62. The image with the known shadow points may also be called a source image. Step 62 may include obtaining the source image from a camera or from another source, such as a storage memory or from another system in the vehicle. The known shadow points may be determined separately and may be provided to the processor 30 and/or determined by the processor 30 based on the source image.

The first method 60 also includes determining of the source image follows a known pattern for the object and determining if any pattern elements are missing at step 64. Step 64 may be performed by the processor 60 which may determine the known pattern based on a ratio of spacing between transitions between relatively bright and dark pixels in the source image. If no pattern elements are missed (i.e. if transitions corresponding to the entire known pattern of the object are found in the source image), then the method proceeds with step 66, indicating that the object is present. If one or more pattern elements are missed in the source image (i.e. if not all transitions corresponding to the entire known pattern of the object are found in the source image), then the method proceeds with step 68.

The first method 60 includes determining a type of a missing edge at step 68. The type of the missing edge may be dark (i.e. representing a transition from a relatively bright region to a relatively dark region), or bright (i.e. representing a transition from a relatively dark region to a relatively bright region). The missing edge may correspond to a next transition after a shadow boundary.

The first method 60 includes finding a location of the missing edge based on a next minimum slope value at step 70 and in response to determining the type of the missing edge being dark. The next minimum slope value may include a location of a local minimum of values representing rates of change of the brightness values of the source image along a scan line and after the shadow boundary.

The first method 60 also includes finding a location of the missing edge based on a next maximum slope value at step 72 and in response to determining the type of the missing edge being bright. The next minimum slope value may include a location of a local maximum of values representing rates of change of the brightness values of the source image along a scan line and after the shadow boundary.

The first method 60 also includes validating missing transitions at step 74, which may include comparing the location of the missing edge found in one of steps 70 or 72 with an estimated location of the missing edge based on the known pattern and based on pattern elements found previously. In some embodiments, step 74 may include validating one or more additional transitions after the first missing edge after the shadow boundary.

The first method 60 also includes determining the object being present at step 76 in response to detecting transitions corresponding to the known pattern of the object.

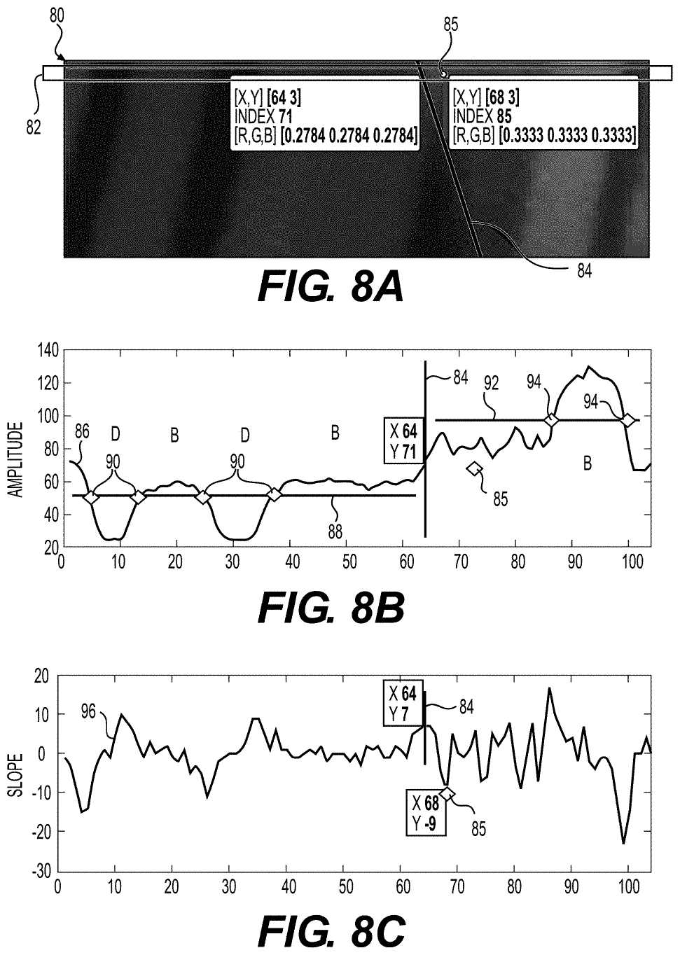

FIGS. 8A-8C show a source image 80 including a row 82 of the source image 80 that may be scanned to detect an object in the source image 80, and corresponding graphs of brightness and of a rate of change (i.e. slope) of the brightness of pixels along the row 82 of the source image 80. FIG. 8A shows the source image 80 of the object with a known pattern and with a boundary 84 of a shadow overlying the known pattern. The object may include the seatbelt 50. However, the system and method of the present disclosure may be used to detect other types of objects.

The shadow boundary 84 shown in FIG. 8A-8C represents a boundary between an area in shadow (i.e. a darker area) before the shadow boundary 84 and an area out of shadow (i.e. a brighter area) after the shadow boundary 84. However, the system and method of the present disclosure may apply to an opposite configuration, where the shadow boundary 84 represents a start of a shadow, with the darker area being defined after the shadow boundary 84. The boundary of the shadow may cross one or more elements of the known pattern on the object, making detection of the known pattern difficult or impossible using conventional methods.

The location of the boundary of the shadow may be known to the system and method of the present disclosure. For example, the system and/or method of the present disclosure may calculate or otherwise determine the location of the boundary of the shadow. Alternatively or additionally, the location of the boundary of the shadow may be communicated to the system and/or method of the present disclosure by an external source, such as an external electronic controller. Obtaining location of the boundary of the shadow is outside of the scope of the present disclosure.

FIG. 8B shows a brightness graph 86 showing amplitude (i.e. brightness values) of pixels along the row 82 of the source image of FIG. 8A. FIG. 8B indicates a missing transition 85, which is a first transition after the shadow boundary 84. FIG. 8B shows detections of first transitions 90 between dark regions (D) and bright regions (B) in the shadow region prior to the shadow boundary 84. In a first length of the graph of FIG. 8B, up to the shadow boundary 84, the first transitions 90 may be determined based on the brightness values 86 crossing a first threshold value 88. FIG. 8B also shows detections of second transitions 94 between dark regions (D) and bright regions (B) in the non-shadow region after to the shadow boundary 84. In a second length of the graph of FIG. 8B, after the shadow boundary 84, the second transitions 94 may be determined based on the brightness values 86 crossing a second threshold value 92, which is different from the first threshold value 88. The missing transition 85 may not correspond to either of the threshold values 88, 92. In other words, the shadow boundary 84 may obscure the missing transition 85.

FIG. 8C shows a slope graph 96 indicating a rate of change of the brightness values of the pixels along the row of the image of FIG. 8A. The missing transition 85 may be determined based on the slope of the brightness values. In the example shown on FIG. 8C, the missing transition 85 is a missing dark edge (i.e. a transition between a relatively bright region and a relatively bright region). The missing transition 85 is detected as a local minimum (i.e. a trough) in the slope graph. The local minimum may include a location where the slope of the brightness values changes from decreasing to increasing. Some filtering, such as requiring minimum amounts or lengths of increasing and/or decreasing, may be used to prevent false detections of a local minimum, which may be caused by noise or other factors.

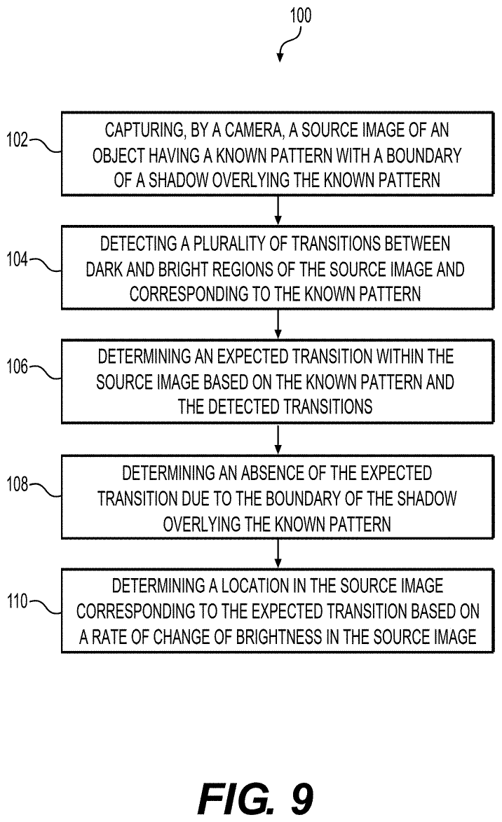

A second method 100 for detecting an object having a known pattern with a boundary of a shadow overlying the known pattern is shown in the flow chart of FIG. 9. The object may include an object within a vehicle, such as a seatbelt. However, the second method 100 of the present disclosure may be used to detect other objects within a vehicle, such as a location of a seat in the vehicle. The known pattern may include stripes which may extending lengthwise along a length of the object. However, one or more other patterns may be used, such as cross-hatching and/or a pattern of shapes, such as a repeating pattern of geometric shapes. In some embodiments, the boundary of the shadow overlying the known pattern is known.

The second method 100 includes capturing, by a camera, a source image of an object having a known pattern with a boundary of a shadow overlying the known pattern at step 102. Step 102 may include capturing the image in the near infrared (NIR) spectrum, which may include detecting reflected NIR light provided by a near-infrared light source 26. However, other types or wavelengths of light may be used. For example, the second method 100 may use one or more colors of visible or invisible light. Step 102 may further include transmitting the image, as a video stream or as one or more still images, from the camera 20 to a control system 13 having a processor 30 for additional processing.

The second method 100 also includes detecting a plurality of transitions between dark and bright regions of the source image and corresponding to the known pattern at step 104. The processor 30 may perform step 104, which may include scanning across a line of the source image, such as a horizontal line which may also be called a row. The processor 30 may compare brightness levels of pixels along the line to a predetermined threshold to determine each of the plurality of transitions between the dark and bright regions. The predetermined threshold may be a local threshold, which may be based on one or more characteristics of an area around the pixels being compared. For example, the characteristics 30 may determine the predetermined threshold based on an average brightness of a region around the pixels being compared. In some embodiments, step 104 may include detecting fewer than all of the transitions in the known pattern of the object.

In some embodiments, step 104 includes scanning across a line in the source image, such as a horizontal row, and comparing brightness values of pixels in the line to a first threshold value. The first threshold value may be predetermined. Alternatively or additionally, the first threshold value may be determined based on or more factors to cause the transitions of the known pattern to be detectable. For example, the first threshold value may be determined based on an average brightness value of a region of the source image including a portion of the object up to the boundary of the shadow. The rate of change of the brightness in the source image may include a rate of change of the brightness values of the pixels in the line.

In some embodiments, step 104 also includes comparing brightness values of pixels in the line and after the boundary of the shadow to a second threshold value different from the first threshold value. The second threshold value may be predetermined. Alternatively or additionally, the first threshold value may be determined based on or more factors to cause the transitions of the known pattern after the boundary of the shadow to be detectable. For example, the second threshold value may be determined based on an average brightness value of a region of the source image including the portion of the object after the boundary of the shadow.

In some embodiments, step 104 also includes converting the source image to black-and-white (B/W). The terms black and white may include any representations of pixels in one of two binary states representing dark or light. The processor 30 may perform this conversion, which may include using a localized binary threshold to determine whether any given pixel in the B/W image should be black or white. Such a localized binary threshold may compare a source pixel in the source image to nearby pixels within a predetermined distance of the pixel. If the source pixel is brighter than an average of the nearby pixels, the corresponding pixel in the B/W image may be set to white, and if the source pixel is less bright than the average of the nearby pixels, then the corresponding pixel in the B/W image may be set to black. In some embodiments, the predetermined distance may be about 100 pixels. In some embodiments, the predetermined distance may be equal to or approximately equal to a pixel width of the seatbelt 50 with the seatbelt 50 at a nominal position relative to the camera (e.g. in use on an occupant 44 having a medium build and sitting in the seat 18a in an intermediate position.

In some embodiments, step 104 also includes scanning across a line in the B/W image to detect the plurality of transitions. The line may include a straight horizontal line, also called a row. However, the line may have another orientation and/or shape.

The second method 100 also includes determining an expected transition within the source image based on the known pattern and the detected transitions at step 106. The processor 30 may perform step 106, which may include comparing one or more properties of the detected transitions, such as a pattern in the relative distances therebetween, with the known pattern. Step 106 may include detecting a part of the known pattern less than the entirety of the known pattern. Step 106 may require a minimum number of detected transitions to be determined and to correspond with the known pattern, in order to reduce a risk of false-detections that could result from transitions not caused by the known pattern of the object. Step 106 may include calculating or otherwise determining the expected transition based on the detected part of the known pattern. Step 106 may include determining a position of the expected transition based on one or more additional factors, such as a scale factor based on a distance between two or more of the detected transitions, which may vary based on a distance between the object and the camera 20 and/or an angle of the object relative to the camera 20.

The second method 100 also includes determining an absence of the expected transition due to the boundary of the shadow overlying the known pattern at step 108. The processor 30 may perform step 108, which may include comparing the location of the expected transition to a location of the boundary of the shadow. In some embodiments, step 108 may include determining the absence of the expected transition being due to the boundary of the shadow only where the expected transition is located after the boundary of the shadow. In some embodiments, step 108 may include determining the absence of the expected transition being due to the boundary of the shadow only where the expected transition is located within a predetermined distance from the boundary of the shadow.

The second method 100 also includes determining a location in the source image corresponding to the expected transition based on a rate of change of brightness in the source image at step 110. The rate of change of the brightness may also be called a slope of the brightness. The processor 30 may perform step 108, which may include calculating a rate of change of brightness values for each of a plurality of pixels in the source image, and comparing one or more values of the rate of change to a threshold value to a value or to a particular pattern. Step 110 may provide a detection of the portion of the known pattern and which corresponds to the expected transition.

In some embodiments, and where the expected transition is a transition from a bright region to a dark region, step 110 includes determining a local minimum of the rate of change of the brightness in the source image. An example of such a local minimum corresponding to the location in the source image corresponding to the expected transition is shown graphically on FIG. 8C. In some embodiments, determining the local minimum of the rate of change of the brightness in the source image includes determining a first local minimum after the boundary of the shadow overlying the known pattern.

In some embodiments, and where the expected transition is a transition from a dark region to a bright region, step 110 includes determining a local maximum of the rate of change of the brightness in the source image. This may be an opposite of the example shown graphically in FIGS. 8A-8C. In some embodiments, determining the local maximum of the rate of change of the brightness in the source image includes determining a first local maximum after the boundary of the shadow overlying the known pattern.

In some embodiments, dedicated hardware implementations, such as application specific integrated circuits, programmable logic arrays, and other hardware devices, can be constructed to implement one or more steps of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation, and change, without departing from the spirit of this invention, as defined in the following claims.

What is claimed is:

1. A method for detecting an object having a known pattern with a boundary of a shadow overlying the known pattern, comprising:
capturing, by a camera, a source image of the object;
detecting a plurality of transitions between dark and bright regions of the source image and corresponding to the known pattern;
determining an expected transition within the source image based on the known pattern and the detected transitions;
determining an absence of the expected transition due to the boundary of the shadow overlying the known pattern; and
determining a location in the source image corresponding to the expected transition based on a rate of change of brightness in the source image.

2. The method of claim 1, wherein the location of the boundary of the shadow overlying the known pattern is known.

3. The method of claim 1, wherein detecting the plurality of transitions between dark and bright regions of the source image further comprises scanning across a line in the source image and comparing brightness values of pixels in the line to a first threshold value, and wherein the rate of change of the brightness in the source image includes a rate of change of the brightness values of the pixels in the line.

4. The method of claim 3, wherein detecting the plurality of transitions between dark and bright regions of the source image further comprises comparing brightness values of pixels in the line and after the boundary of the shadow to a second threshold value different from the first threshold value.

5. The method of claim 1, wherein detecting the plurality of transitions between dark and bright regions of the source image further comprises:
converting the source image to a black-and-white image; and
scanning across a line in the black-and-white image to detect the plurality of transitions.

6. The method of claim 1, wherein the expected transition is a transition from a bright region to a dark region, and wherein determining the location in the source image corresponding to the expected transition includes determining a local minimum of the rate of change of the brightness in the source image.

7. The method of claim 6, wherein determining the local minimum of the rate of change of the brightness in the source image includes determining a first local minimum after the boundary of the shadow overlying the known pattern.

8. The method of claim 1, wherein the expected transition is a transition from a dark region to a bright region, and wherein determining the location in the source image corresponding to the expected transition includes determining a local maximum of the rate of change of the brightness in the source image.

9. The method of claim 8, wherein determining the local maximum of the rate of change of the brightness in the source image includes determining a first local maximum after the boundary of the shadow overlying the known pattern.

10. The method of claim 1, wherein capturing the image of the object includes capturing the image in near infrared (NIR).

11. The method of claim 1, wherein the object includes a seatbelt.

12. The method of claim 1, wherein the known pattern includes stripes extending lengthwise along a length of the object.

13. A system for detecting a position of an object having a known pattern with a boundary of a shadow overlying the known pattern, comprising:
a camera configured to capture a source image of the object; and
a controller in communication with the camera and configured to:
detect a plurality of transitions between dark and bright regions of the source image and corresponding to the known pattern;
determine an expected transition within the source image based on the known pattern and the detected transitions;
determine an absence of the expected transition due to the boundary of the shadow overlying the known pattern; and
determine a location in the source image corresponding to the expected transition based on a rate of change of brightness in the source image.

14. The system of claim 13, wherein the location of the boundary of the shadow overlying the known pattern is known.

15. The system of claim 13, wherein detecting the plurality of transitions between dark and bright regions of the source image further comprises the controller being configured to scan across a line in the source image and to compare brightness values of pixels in the line to a first threshold value, and wherein the rate of change of the brightness in the source image includes a rate of change of the brightness values of the pixels in the line.

16. The system of claim 15, wherein detecting the plurality of transitions between dark and bright regions of the source image further comprises the controller being configured to compare brightness values of pixels in the line and after the boundary of the shadow to a second threshold value different from the first threshold value.

17. The system of claim 13, wherein the expected transition is a transition from a bright region to a dark region, and wherein determining the location in the source image corresponding to the expected transition includes determining a local minimum of the rate of change of the brightness in the source image.

18. The system of claim 17, wherein determining the local minimum of the rate of change of the brightness in the source image includes determining a first local minimum after the boundary of the shadow overlying the known pattern.

19. The system of claim 13, wherein the expected transition is a transition from a dark region to a bright region, and wherein determining the location in the source image corresponding to the expected transition includes determining a local maximum of the rate of change of the brightness in the source image.

20. The system of claim 19, wherein determining the local maximum of the rate of change of the brightness in the source image includes determining a first local maximum after the boundary of the shadow overlying the known pattern.
